(19) United States
(12) Patent Application Publication
(10) Pub. No.: US 2025/0346973 A1
(43) Pub. Date: Nov. 13, 2025

(54) PROCESSING TECHNIQUES FOR SPENT LITHIUM-ION BATTERY ANODE MATERIALS

(71) Applicants: Ye Bai, Chengdu (CN); Dashuai Li, Chengdu (CN)

(72) Inventors: Ye Bai, Chengdu (CN); Dashuai Li, Chengdu (CN)

(73) Assignee: Chengdu Landmarks Technology Co., Ltd, Chengdu (CN)

(21) Appl. No.: 18/661,575

(22) Filed: May 11, 2024

(51) Int. Cl. C22B 7/00; C22B 3/22; C22B 4/02; C22B 26/12; H01M 10/54

(52) U.S. Cl. CPC C22B 7/001; C22B 3/22; C22B 4/02; C22B 26/12; H01M 10/54

(57) ABSTRACT

A technique for processing the black powder materials of spent Li-ion battery cathodes is described. The black powder materials of spent Li-ion battery cathodes are irradiated by high frequency electromagnetic fields. Under the action of mechanical oscillation and temperature rising, the black powder materials of spent Li-ion battery cathodes decompose and recombine. The water-soluble Li-based materials are separated from the metal oxide solids which are insoluble by water washing, and finally the lithium-ion solution and metal oxide solids are obtained. The method uses high frequency electromagnetic fields to irradiate the black powder materials of spent Li-ion battery cathodes and wash the product by water, which has the advantages of green, high efficiency, rapid, etc., and is an important technique of processing spent Li-ion batteries.

### BACKGROUND

The present invention relates to the area of processing black powder materials technique for the lithium-ion battery area. More particularly, it relates to a technique for processing the black powder materials of spent lithium-ion battery cathodes.

The lithium-ion battery production and market grow rapidly with the development of the global new energy industry. Its application spreads in many areas widely, such as electric automobile, cell phone and so on. However, the storage capacity of lithium-ion battery will appear irreversible decay after a period of charge and discharge, and generally their service life is not more than 8 years. Due to the existence of a large number of organic electrolytes as well as adhesives, conductive materials, etc. in lithium-ion batteries, these spent lithium-ion batteries will have turn into a great environmental pollution on the earth. Because anode materials contain a large number of lithium, cobalt, nickel, manganese and other precious metals spent lithium-ion batteries are also an important source of valuable metals which are typical urban mineral resources at same time. Green and efficient disposal of spent lithium-ion batteries is a major issue that the energy storage industry needs to solve. The technologies breakthrough in the area can not only solve the problem in environmental pollution, but also promote the rapid development of the new energy industry, and truly is green materials manufacturing in clean energy industry.

The anode of a lithium-ion battery is an important component, accounting for 30% of the total value of the battery. The capacity of lithium-ion batteries declines by the reduction of lithium ions in the anode. The benefits of processing the spent lithium-ion batteries mainly come from processing the black powder materials of cathodes. The traditional processing ways include the dry and wet processing parts. The dry processing is that the black powder materials to be baked for a long time under the condition of high temperature, then in wet processing acid and alkali are used for dissolving, precipitating and separating the valuable metals. The technique is high energy consumption, unfriendly environment, production capacity restricted by many factors and the production quality cannot be assured.

The present invention is the results from the interdisciplinary subject research between electromagnetic and materials areas. Compared with traditional processing technique it has the characteristics of low energy consumption, fast processing, and environment friend. It is an efficient and green processing technique for spent lithium-ion batteries.

The technique can not only deal with spent lithium-ion batteries green and effectively, but also protect the earth's ecology and create a lot of economic value.

### SUMMARY

A technique for the processing spent lithium-ion batteries in the present invention. It aims to overcome the shortcomings of the prior technique, such as high energy consumption, heavy pollution, long processing time, complex processing, etc., provide an efficient and green processing technique for the black powder materials of spent lithium-ion battery cathodes.

More specifically, the present invention-processing the black powder materials of spent lithium-ion battery cathodes includes the related technique: irradiating by high-frequency electromagnetic fields, washing products by water and liquid-solid separation for the invention purpose.

There are a large number of valuable metals such as Ni, Co, Mn, Li, etc. in the black powder materials of spent lithium-ion battery cathodes, the black powder materials form a polarization structure of molecules similar to olivine. When high-frequency electromagnetic fields irradiate on the black powder materials the polar molecules of the black powder materials will oscillate with high-frequency electromagnetic fields. At same time the energy conversion from electromagnetic energy to molecular kinetic energy will generate. This action will make the black powder material temperature rising. As soon as the kinetic energy of polar molecules is more than a certain critical value by the bond energy between atoms (or molecules) the connection among these polar molecules will break, the black powder materials convert to Li ions and other free ions, molecules and other products. Due to high-frequency electromagnetic fields the temperature for breaking the connection among atoms and molecules is much lower than that by baking processing. Besides the penetration of electromagnetic fields makes the energy conversion both inside and surface on the black powder materials at same time, the processing time reduces greatly, moreover the adhesives (PVDF) and electrical conductors (carbon) in black powder materials are oxidized into water and carbon dioxide. In products the metal oxides (such as MnO, Co₃O₄, Fe₂O₃ etc.) are insoluble in water and the Li-based materials (such as Li₂O, LiH₂PO₄, Li₂CO₃, etc.) are water-soluble, the metal oxide solid and the lithium containing solution can be obtained by water-washing the products and liquid-solid separation. By this way the valuable metal oxides are extracted from the black powder materials of the spent lithium-ion battery cathodes.

The present invention is implemented as follows:

The present invention introduces high-frequency electromagnetic fields into processing the black powder materials of spent lithium-ion battery cathodes. The black powder materials of the anode are irradiated by high-frequency electromagnetic fields for a period of time, then put into the mixing system to mix and mill evenly. For more complete processing the above procedure is repeated several times until the black powder materials is completely conversed. After cooling the product is ground into powder, mixed with pure water, and then put into the centrifugal system for solid-liquid separation. Finally the Li-based materials and valuable metal oxides such as MnO, Co₃O₄ etc. are extracted from the black powder materials of the spent lithium-ion battery cathodes.

### BRIEF DESCRIPTION OF THE DRAWINGS

For a more complete understanding of the present invention and for further details and advantages thereof, reference is now made to the following drawings and descriptions thereof.

FIG. 1 shows the comparison of the flows for processing the black powder materials of spent lithium-ion battery cathodes. The left dashed box is the traditional processing technique, and the right dashed box is the processing technique in the present invention.

FIG. 2 shows the conversion of the black powder materials of ternary lithium battery cathodes by high frequency electromagnetic field irradiation. By high-frequency electromagnetic fields, the black powder materials of ternary lithium battery cathodes are decomposed into Li₂CO₃ and the metal oxides.

### DETAILED DESCRIPTION OF SPECIFIC EMBODIMENTS

In the following, a specific embodiment of the present invention will be described in detail with reference to the accompanying drawings such that those skilled in the art can better understand the invention. It is noted that well-known functions and configurations are not described in detailed to avoid obscuring the present invention.

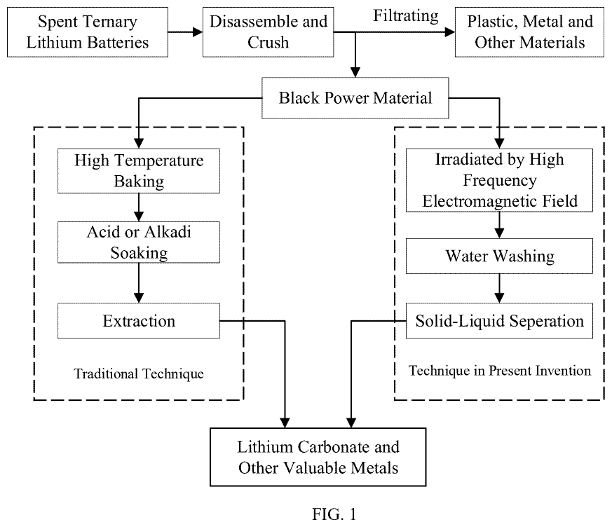

FIG. 1 is the comparison of the processing ways for the spent lithium-ion batteries. As shown in FIG. 1, the right dashed box is the processing flow of the black powder materials of the spent lithium-ion battery cathodes in the present invention.

In this embodiment, the processing is divided into three parts successively: irradiating by high-frequency electromagnetic fields, washing products by water, and solid-liquid separation.

In this embodiment, the irradiation of high-frequency electromagnetic fields is that high-frequency electromagnetic fields irradiate on the black powder materials of the spent lithium-ion battery cathodes for a period of time, then milling and mixing the product; The procedure is repeated for several times until the black powder materials are completely processed.

In this embodiment, washing products by water is grinding the product having irradiated by a high-frequency electromagnetic fields at first, then injecting pure water into the powder product, mixing it fully, finally obtaining solid precipitate and aqueous solution.

In this embodiment, the liquid-solid separation is the separation of the solid precipitate and the aqueous solution obtained in above step by centrifugal method, and finally the metal oxides and the Li-ion containing solution are obtained. Thus, green processing the black powder materials of spent lithium-ion battery cathodes and extraction of valuable metals can be implemented.

The following is further explained as an implementation case of the present invention by processing black powder materials of spent ternary lithium battery cathodes.

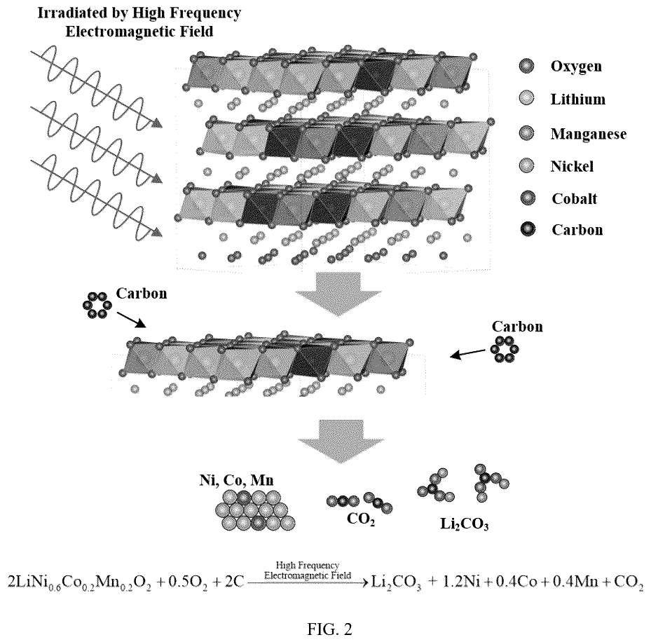

FIG. 2 shows the reaction of black powder materials of spent ternary lithium battery cathodes under the irradiation of high-frequency electromagnetic fields.

Under the irradiation of high frequency electromagnetic fields, the polar molecules of black powder materials oscillate mechanically with high frequency electromagnetic fields, the energy conversion from electromagnetic energy to molecular kinetic energy will generate. As soon as the kinetic energy of polar molecules is more than a certain critical value of the bond energy between atoms (or molecules) the connection in these polar molecules will break, the black powder materials convert to Li-ions and other free ions, molecules and other products. They react with oxygen molecules, then the metal oxides (MnO, Co₃O₄, Fe₂O₃ etc.) are produced. At the same time the adhesives (PVDF) and electrical conductors (carbon) in black powder materials are oxidized to water and carbon dioxide. Due to high-frequency electromagnetic fields the above reaction temperature is much lower than that in traditional processing. Besides the penetration of high-frequency electromagnetic fields makes the energy conversion both inside and surface on the black powder materials at same time. The energy and time of the reaction are much lower than traditional processing under high-temperature baking. The products-Li₂O is water soluble and the other metal oxides (MnO, Co₃O₄, Fe₂O₃ etc.) are insoluble. The products are put into mixing systems to mix and mill evenly. For more completely processing the above procedure is repeated several times until the black powder materials is completely conversed. After cooling the product is ground into powder, mixed with pure water, and then put into the centrifugal system for solid-liquid separation. Finally valuable metals such as Li, Mn, Co, Ni are extracted from the black powder materials of spent ternary lithium battery cathodes. Because of water used for in washing and separation, there is no environmental pollution caused by acids, alkalis or organic solvents in processing.

For other types of lithium-ion batteries, such as lithium manganate batteries, Lithium cobaltate batteries, etc., processing the black powder materials can also adopt the present invention for because of their polarity molecules.

### GENERAL

Without any loss of generality, the present invention can be used in processing the black powder materials of lithium-ion battery cathodes, such as ternary lithium, lithium manganate, lithium cobaltate, lithium iron phosphate batteries etc. Additionally, practitioners can also use the present invention more generally in other area according to their need in lithium-ion batteries.

Unless specifically stated otherwise, as apparent from the following discussions, it is appreciated that throughout the specification discussions utilizing terms such as “irradiation from high frequency electromagnetic fields”, “washing the products by water”, “Ternary lithium batteries”, “Lithium manganate”, “Lithium cobaltate”, “Lithium iron phosphate batteries” or the like, refer to the action and/or processes. In a similar manner, the term “processing the black powder materials of lithium-ion battery cathodes” may refer to “materials processing” and may refer to any device. Unless specifically state otherwise, the terms “high frequency electromagnetic fields” and “microwave” are used interchangeably. The methodologies described herein are, in one embodiment, can be performed by one or more areas. In such embodiments, any system capable of executing this set of the processing the black powder materials of spent lithium-ion battery cathodes that specifies actions to be taken may be included. Thus, one example is the processing the black powder materials of spent ternary lithium battery cathodes. Note that when a method includes several elements, e.g., several steps, no ordering of such elements is implied, unless specifically stated.

Note that while some diagram(s) only show(s) a structure, those skilled in the art understand that several structures as described above are included, but not explicitly shown or described in order not to obscure the inventive aspect.

Note that, as would be known to one skilled in the art, if the number the units to be produced justifies the cost, any set of instructions in combination with elements. Thus, as will be appreciated by those skilled in the art, embodiments of the present invention may be embodied as a method, an apparatus such as a special purpose apparatus. Accordingly, aspects of the present invention may take the form of a method, an entirely hardware embodiment, an entirely software embodiment or an embodiment combining software and hardware aspects.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly, it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

All publications, patents, and patent applications cited herein are hereby incorporated by reference, except in those jurisdictions where incorporation by reference is not permitted. In such jurisdictions, the Applicant reserves the right to insert portions of any such cited publications, patents, or patent applications if Applicant considers this advantageous in explaining and/or understanding the disclosure, without such insertion considered new matter.

Any discussion of prior art in this specification should in no way be considered an admission that such prior art is widely known, is publicly known, or forms part of the general knowledge in the field.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a system comprising A and B should not be limited to systems consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected”, along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Note that the claims attached to this description form part of the description, so are incorporated by reference into the description, each claim forming a different set of one or more embodiments.

What is claimed is:

1. A technique of processing the black powder materials of spent lithium-ion battery cathodes, the technique comprising:
the irradiation of high-frequency electromagnetic fields, washing products by water and the solid-liquid separation;
wherein the technique is configured such that:
the black powder materials of spent lithium-ion battery cathodes are converted into the Li-based materials and the metal oxides (such as MnO, Co₃O₄, Fe₂O₃ etc.) by the irradiation of high-frequency electromagnetic fields;
the adhesives (polyvinylidene fluoride) and electrical conductors (carbon) in black powder materials are oxidized to water and carbon dioxide due to the irradiation of high-frequency electromagnetic fields;
the washing products from the irradiation of high-frequency electromagnetic fields by water are used for dissolving Li-based materials;
the solid-liquid separation is applied to separate a Li-based materials solution and a metal oxide solid;
the final products of the technique are a Li-based materials solution and a metal oxide solid.

2. The technique of claim 1 wherein the irradiation of high-frequency electromagnetic fields further comprising:
the high-frequency electromagnetic fields irradiate the black powder materials of the spent lithium-ion battery cathodes for a period of time;
the products after the irradiation are milled and mixed;
the irradiation together with the operation of milling and mixing are repeated for several times until the black powder materials are completely processed.

3. The technique of claim 1 wherein the washing products by water comprises a step of putting the pure water into the products after the irradiation of high-frequency electromagnetic fields.

4. The technique of claim 1 wherein the final products of Li-based materials solution and metal oxide solid are obtained by centrifugal separation.
